(19) United States
(12) Patent Application Publication
(10) Pub. No.: US 2006/0229012 A1
(43) Pub. Date: Oct. 12, 2006

(54) BLUETOOTH MOBILE PHONE HAVING A DETACHABLE BLUETOOTH EARPIECE

(76) Inventors: Jui-Ming Tsai, Tai-Chung City (TW); Yu-Hu Yan, Tai-Chung Hsien (TW)

Correspondence Address: NORTH AMERICA INTELLECTUAL PROPERTY CORPORATION, P.O. BOX 506, MERRIFIELD, VA, 22116, US

(21) Appl. No.: 11/279,252

(22) Filed: Apr. 11, 2006

(30) Foreign Application Priority Data
Apr. 11, 2005 (TW) 094111370

(51) Int. Cl. H04B 7/00

(52) U.S. Cl. 455/41.2; 455/550.1

(57) ABSTRACT

A Bluetooth mobile phone includes a first module and a second module detachable from the first module. When the first and second modules are separated, signals are wirelessly transmitted between the first and second modules in a Bluetooth mode. When combining the first and second modules, a connection interface of the first module is coupled to a connection interface of the second module, such that signals are substantially transmitted through the two interfaces.

### BACKGROUND OF THE INVENTION

1. Field of the Invention

The present invention relates to a Bluetooth mobile phone, and more particularly, to a Bluetooth mobile phone having a detachable Bluetooth earpiece.

2. Description of the Prior Art

In modern society, wireless communication is available for everyone. People can wirelessly communicate with each other anytime and anywhere via mobile phones. However, it is sometimes inconvenient to use a mobile phone when driving a car or doing something with both hands. Therefore, a user can utilize a headset or earpiece wired or wirelessly connected to the mobile phone, giving the mobile phone hands-free convenience. The weight of the headset or earpiece is usually lighter than that of the mobile phone, and the headset or earpiece is capable of being worn on the head or hung on the ear. If the headset or earpiece is connected to the mobile phone via Bluetooth radio technology, all calls are wirelessly transmitted from the mobile phone to the headset or earpiece. Even if the mobile phone is inside a briefcase, a pocket, or across the room, the user can still talk freely.

However, most earpieces are substantially connected to the mobile phone with a wire. The user must hang the mobile phone on the waist or put it in a pocket so as to ensure the connection between the mobile phone and the earpiece. This is really inconvenient for the user. When the user is not using the earpiece, it is troublesome to store the earpiece and the wire. A few wireless earpieces, such as Bluetooth earpieces, solve the problem of the wire, but the user has to carry the mobile phone and the Bluetooth earpiece separately, which is still inconvenient. When the user does not need the Bluetooth earpiece, the Bluetooth earpiece becomes a redundant element, and is easily lost. Additionally, there is another problem for charging the earpiece in the prior art. Most wireless Bluetooth earpieces require extra battery chargers. Therefore, the user must use individual battery chargers for the mobile phone and the earpiece. This is inconvenient and much trouble.

### SUMMARY OF THE INVENTION

It is therefore a primary objective of the claimed invention to provide a Bluetooth mobile phone in order to solve the above-mentioned problem.

The claimed invention provides a Bluetooth mobile phone comprising a first module and a second module. The first module comprises a first housing, a user operation interface positioned on the first housing, a wireless communication module for transmitting and receiving wireless signals, a processor located inside the first housing and coupled to the wireless communication module for controlling the operation of the first module, a first Bluetooth module coupled to the processor for transmitting/receiving and processing Bluetooth signals, and a first connection interface. The second module comprises a second housing detachably connected with the first housing, a second Bluetooth module for transmitting/receiving and processing Bluetooth signals, a microphone positioned in the second housing for inputting audio signals to the first or the second module, a speaker positioned in the second housing for outputting audio signals from the first or the second module, and a second connection interface for being electrically connected to the first connection interface.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1 and 2 are diagrams of modules of a Bluetooth mobile phone based on the present invention.

FIG. 3 is a front view of the Bluetooth mobile phone of the present invention.

FIG. 4 is a rear view of the Bluetooth mobile phone of FIG. 3.

FIG. 5 is a rear view of the Bluetooth mobile phone of FIG. 3 without the second module.

FIG. 6 to FIG. 8 are other embodiments of the Bluetooth mobile phone of the present invention.

### DETAILED DESCRIPTION

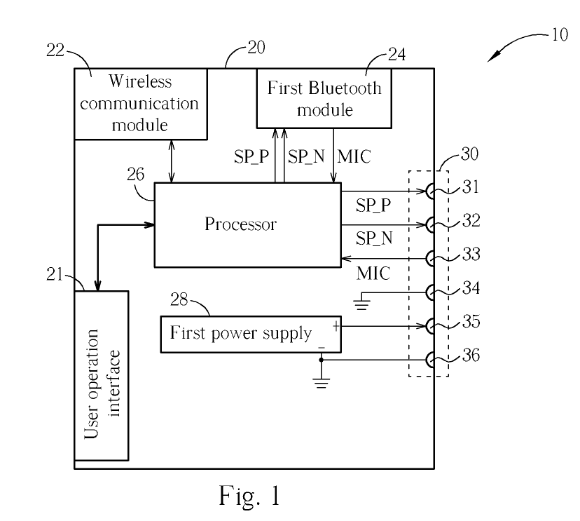

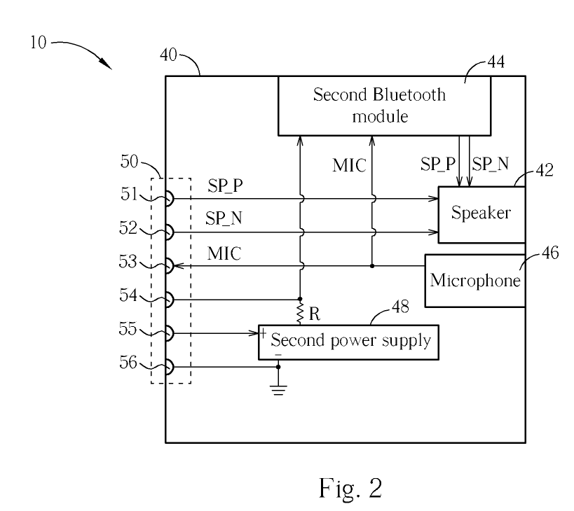

Please refer to FIGS. 1 and 2, which are respectively diagrams of a first module 20 and a second module 40 of a Bluetooth mobile phone 10 according to the present invention. The Bluetooth mobile phone 10 comprises two parts, the first module (mobile phone) 20 of FIG. 1 and the second module (Bluetooth earpiece) 40 of FIG. 2. The first module 20 comprises a wireless communication module 22, a first Bluetooth module 24, a processor 26, a first power supply 28, a first connection interface 30, and a user operation interface 21. The second module 40 comprises a speaker 42, a second module 44, a microphone 46, a second power supply 48, and a second connection interface 50.

The wireless communication module 22 of the first module 20 receives wireless signals of a wireless communication system, and transmits wireless signals to the system. The processor 26 controls the operation of the first module 20. A user can make a call or send a message via the user operation interface 21.

When the first module 20 is combined with the second module 40, the first connection interface 30 of the first module 20 is coupled to the second connection interface 50 of the second module 40. The first connection interface 30 includes six nodes 31˜36, and the second connection interface 50 includes nodes 51˜56 correspondingly, as shown in FIGS. 1 and 2. Audio signals are transmitted from the nodes 31 and 32 of the first connection interface 30 to the nodes 51 and 52 of the second module 40, and then output by the speaker 42. The voice of the user is collected by the microphone 46 of the second module 40, and transmitted to the first module 20 through the node 53 of the second connection interface 50. The node 33 of the first connection interface 30 receives and transmits audio signals to the processor 26. Finally, audio signals are transformed by the wireless communication module 22 and transmitted to the wireless communication system.

Additionally, elements of the second module 40 require less power than those of the first module 20. The present invention enables the first power supply 28 to charge the second power supply 48 when the two modules 20 and 40 are combined. This ensures that the second power supply 48 can provide power to the second module 40 anytime. The nodes 35 and 36 of the first connection interface 30 correspond to the nodes 55 and 56 of the second connection interface 50 when combining the two modules 20 and 40. The nodes 35 and 55 are connected to a positive potential while nodes 36 and 56 are connected to ground so that the second power supply 48 is charged by the first power supply 28.

The prior art needs two battery chargers for the phone and the Bluetooth earpiece. However, the first power supply 28 of the present invention charges the second power supply when the first connection interface 30 is coupled to the second connection interface 50. In this way, the present invention can reduce peripheral equipment for the Bluetooth mobile phone 10. The first power supply 28 acts as the battery charger for the Bluetooth earpiece. When the charge of the Bluetooth earpiece is almost consumed, the Bluetooth earpiece receives charge from the mobile phone instead of an extra battery charger.

Next, the following introduces how to start Bluetooth wireless communication. When the first module 20 and the second module 40 separate, the first Bluetooth module 24 of the first module 20 and the second Bluetooth module 44 of the second module 40 are subsequently started, such that signals are transmitted between the first module 20 and the second module 40 in a Bluetooth mode wirelessly. The node 54 of the second connection interface 50 is connected to a resistor R and the second Bluetooth module 44. The other end of the resistor R is connected to the second power supply 48. When the two modules 20 and 40 are combined, the node 54 is coupled to the node 34, and the voltage of the node 54 drops to the ground voltage due to the node 34 being connected to the ground. Conversely, when the two modules 20 and 40 separate, the voltage of the node 54 increases and equals the positive potential of the first power supply 48. The voltage change of the node 54 is regarded as an interrupt signal to inform the second module 40 that the Bluetooth earpiece has been separated from the phone so as to start the second Bluetooth module 44. The first module 20 detects the state of the node 33 to determine whether the two modules 20 and 40 are separated. When the two modules 20 and 40 are combined, the voltage of the microphone is lower. On the contrary, when the two modules 20 and 40 are separated, the voltage of the microphone increases. The processor 26 can determine whether the two modules 20 and 40 are separated because the voltages of the node 33 are different when the two modules 20 and 40 are separated or combined. When the processor 26 detects that the two modules 20 and 40 are separated, the first Bluetooth module 24 is started. Otherwise, the processor 26 disables the first Bluetooth module 24.

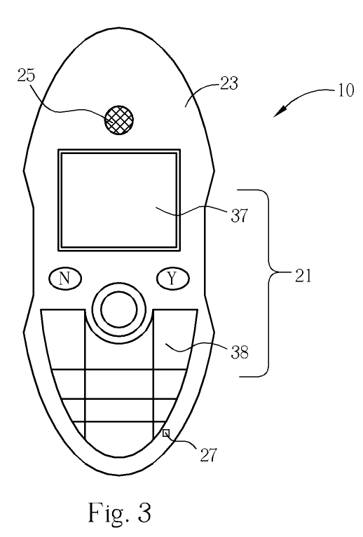

The above is a description of elements of the first module 20 and the second module 40. The following are instructions on how to combine the mobile phone and the Bluetooth earpiece. Please refer to FIG. 3, which is a front view of the Bluetooth mobile phone 10 of the present invention. In FIG. 3, the first housing 23 of the Bluetooth mobile phone 10 includes a hole 25 and an opening 27. There is a user operation interface having a display 37 and a keyboard 38 positioned on the first housing 23. When combining the first module 20 and the second module 40, the user can listen in to a call through the hole 25 and the opening 27. Please note that combinations of housings are not intended to be limited by these examples. Any method capable of combining the housings can be implemented in the present invention.

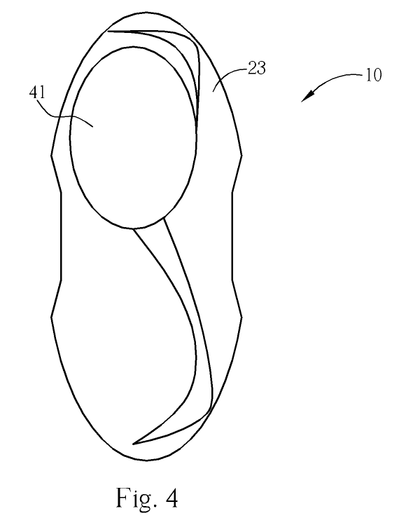

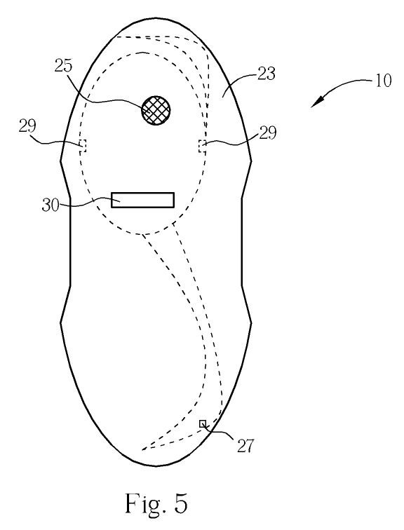

Please refer to FIG. 4, which is a rear view of the Bluetooth mobile phone 10. The second housing 41 of the second module 40 includes an engaging element for engaging with an engaging element 29 of the first housing 23 (please refer to FIG. 5), so that the Bluetooth earpiece is combined with the phone, as shown in FIG. 4. In addition, the second housing 41 of FIG. 4 is capable of being hung on the user's ear. When the user is doing something with both hands and is unable to hold the mobile phone, detaching the Bluetooth earpiece from the phone and hanging the earpiece on the user's ear enables the user to use the mobile phone with hands-free convenience. Of course, when the user does not want use the Bluetooth earpiece, the earpiece can be conveniently combined with the mobile phone to prevent the earpiece from becoming lost.

Please refer to FIG. 5, which is a rear view of the Bluetooth mobile phone 10 without the second module 40. The dashed lines in FIG. 5 represent the space of the second module 40 combined with the phone. The hole 25 and the opening 27 respectively correspond to the speaker 42 and the microphone 46 of the second module 40 for outputting and inputting audio signals. When the mobile phone and the Bluetooth earpiece are combined, the connection interface 30 of the first module 20 is directly connected to the connection interface 50 of the second module 40 for substantially transmitting signals.

In FIG. 3 to FIG. 5, the length of the housing of the Bluetooth earpiece is shorter than the length of the housing of the mobile phone. Therefore, the first housing 23 must include the hole 25 and the opening 27 so that the user can listen in to voice transmitted from the speaker 42 or input their own voice at the microphone 46.

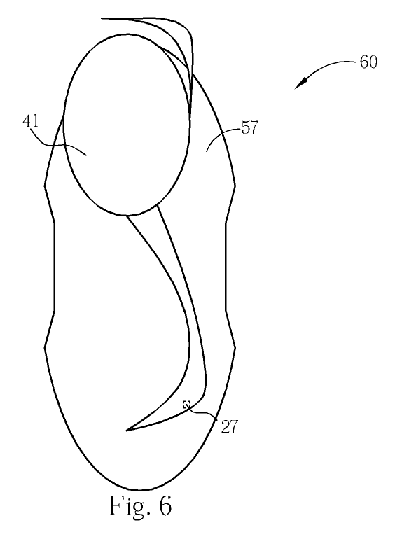

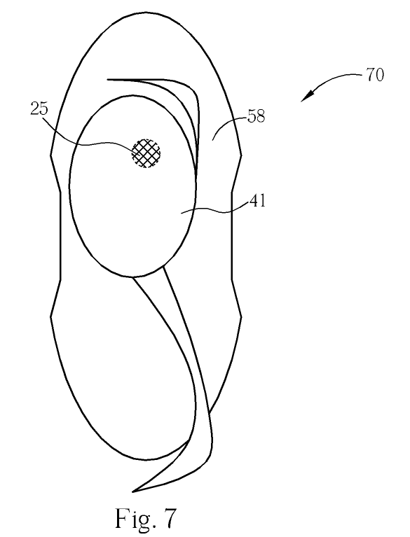

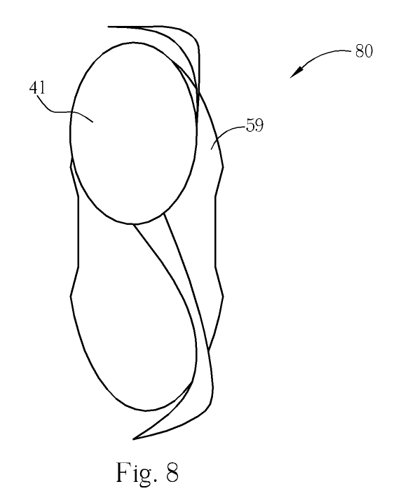

Please refer to FIG. 6 to FIG. 8, which are other structures of the Bluetooth mobile phone of the present invention. As shown in FIG. 6, the first housing 57 of the Bluetooth mobile phone 60 includes the opening 27 (as dashed lines), but no hole 25. Therefore, the position of the speaker 42 must be unobstructed by the first housing 23 so that the user can directly listen in to voice output from the speaker 42. Another structure is shown in FIG. 7. The first housing 58 of the Bluetooth mobile phone 70 includes the hole 25 (as dashed lines), but no opening 27. In this embodiment, the position of the microphone 46 must be unobstructed by the first housing 23 so as to enable the user to input voice to the microphone 46. Another method is to change the size of the housing of the phone. If the length of the first housing 59 of the Bluetooth mobile phone 80 is designed shorter than that of the second housing 41, as shown in FIG. 8, the user can directly receive or input voice with the microphone 46 and the speaker 42 instead of through the hole 25 and the opening 27. In the embodiments of FIG. 6 to FIG. 8, the second housing 41 is still capable of being hung on the ear, and positions of the hole 25 and the opening 27 are dependent on positions of the speaker 42 and the microphone 46.

Compared to the prior art, the Bluetooth mobile phone of the present invention solves the prior art problem of carrying the Bluetooth earpiece and the mobile phone separately, and makes it more convenient for the user to store. The present invention only adds several physical contact nodes to the current Bluetooth mobile phone for substantially transmitting signals between the mobile phone and the earpiece. When combining the Bluetooth earpiece and the mobile phone, the mobile phone terminal controls all operations. Voice is transmitted through the speaker and the microphone of the earpiece terminal, and thereby there is no speaker and microphone in the mobile phone terminal, making the mobile phone lightweight. In addition, the mobile phone charges the Bluetooth earpiece when the two pieces are combined, and thereby the user only needs a battery charger for the mobile phone. When the Bluetooth earpiece is detached from the mobile phone, the interrupt signal is used for starting the Bluetooth wireless communication mode. The present invention not only provides a hands-free and wire-free solution, but also solves the prior art problems of carrying the phone and the earpiece separately.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A Bluetooth mobile phone comprising:
a first module comprising:
a first housing;
a user operation interface positioned on the first housing;
a wireless communication module for transmitting and receiving wireless signals;
a processor located inside the first housing and coupled to the wireless communication module for controlling the operation of the first module;
a first Bluetooth module coupled to the processor for transmitting/receiving and processing Bluetooth signals; and
a first connection interface; and
a second module comprising:
a second housing detachably connected with the first housing;
a second Bluetooth module for transmitting/receiving and processing Bluetooth signals;
a microphone positioned in the second housing for inputting audio signals to the first or the second module;
a speaker positioned in the second housing for outputting audio signals from the first or the second module; and
a second connection interface for being electrically connected to the first connection interface.

2. The Bluetooth mobile phone of claim 1 wherein the user operation interface comprises a display and a keyboard.

3. The Bluetooth mobile phone of claim 1 wherein the first module further comprises a first power supply positioned inside the first housing, and the second module further comprises a second power supply positioned inside the second housing.

4. The Bluetooth mobile phone of claim 3 wherein the first power supply charges the second power supply when the first connection interface is electrically connected to the second connection interface.

5. The Bluetooth mobile phone of claim 1 wherein the first housing includes a hole that corresponds to the speaker of the second module when the first housing is combined with the second housing.

6. The Bluetooth mobile phone of claim 1 wherein the first housing includes an opening that corresponds to the microphone of the second module when the first housing is combined with the second housing.

7. The Bluetooth mobile phone of claim 1 wherein when the first and the second connection interfaces are separated, the first module wirelessly communicates with the second module, the speaker outputting audio signals from the second module and the microphone inputting audio signals to the second module.

8. The Bluetooth mobile phone of claim 1 wherein the processor starts the first Bluetooth module when the first and the second connection interfaces separate.

9. A first module of a Bluetooth mobile phone comprising:
a first housing detachably connected with a second housing of a second module;
a user operation interface positioned on the first housing;
a wireless communication module for transmitting and receiving wireless signals;
a processor located inside the first housing and coupled to the wireless communication module for controlling the operation of the first module;
a first Bluetooth module coupled to the processor for transmitting/receiving and processing Bluetooth signals; and
a first connection interface for being coupled to a second connection interface of the second module.

10. The first module of claim 9 further comprising a first power supply positioned inside the first housing.

11. The first module of claim 9 wherein the first housing includes a hole that corresponds to a speaker of the second module when the first housing is combined with the second housing.

12. The first module of claim 9 wherein the first housing includes an opening that corresponds to a microphone of the second module when the first housing is combined with the second housing.

13. The first module of claim 9 wherein the user operation interface comprises a display and a keyboard.

14. The first module of claim 9 wherein the processor starts the first Bluetooth module when the first and the second connection interfaces separate.

15. A first module of a Bluetooth mobile phone comprising:
a first housing detachably connected with a second housing of a second module, the first housing including a hole that corresponds to a speaker or a microphone of the second module when the first housing is combined with the second housing;
a wireless communication module for transmitting and receiving wireless signals;
a processor located inside the first housing and coupled to the wireless communication module for controlling the operation of the first module;
a first Bluetooth module coupled to the processor for transmitting/receiving and processing Bluetooth signals; and
a first connection interface for being coupled to a second connection interface of the second module.

16. The first module of claim 15 further comprising a first power supply positioned inside the first housing.

17. The first module of claim 15 wherein the processor starts the first Bluetooth module when the first and the second connection interfaces separate.

18. A Bluetooth mobile phone comprising:
a first module comprising:
a first housing;
a wireless communication module for transmitting and receiving wireless signals;
a processor located inside the first housing and coupled to the wireless communication module for controlling the operation of the first module;
a first Bluetooth module coupled to the processor for transmitting/receiving and processing Bluetooth signals; and
a first connection interface; and
a second module comprising:
a second housing detachably connected with the first housing;
a second Bluetooth module for transmitting/receiving and processing Bluetooth signals;
a microphone positioned in the second housing for inputting audio signals to the first or the second module;
a speaker positioned in the second housing for outputting audio signals from the first or the second module; and
a second connection interface for being electrically connected to the first connection interface;
wherein the first housing includes a hole that corresponds to the speaker or to the microphone of the second module when the first housing is combined with the second housing.

19. The Bluetooth mobile phone of claim 18 wherein the first module further comprises a first power supply for charging the second module when the first connection interface is electrically connected to the second connection interface.

20. The Bluetooth mobile phone of claim 18 wherein the processor starts the first Bluetooth module when the first and the second connection interfaces separate.
